(19) United States
(12) Patent Application Publication
(10) Pub. No.: US 2005/0056741 A1
(43) Pub. Date: Mar. 17, 2005

(54) Modular safety rail system

(75) Inventors: Philip Maurice Higgs, Berkshire (GB); Charles William Stratford Presant, Berkshire (GB)

Correspondence Address: YOUNG & THOMPSON, 745 SOUTH 23RD STREET, 2ND FLOOR, ARLINGTON, VA, 22202, US

(73) Assignee: KEE KLAMP LIMITED, BERKSHIRE (GB)

(21) Appl. No.: 10/974,752

(22) Filed: Oct. 28, 2004

Related U.S. Application Data
(63) Continuation-in-part of application No. 10/611,982, filed on Jul. 3, 2003, now abandoned.

(30) Foreign Application Priority Data
Jul. 4, 2002 (GB) 0215380.7

(51) Int. Cl. F16M 11/20

(52) U.S. Cl. 248/188.8

(57) ABSTRACT

A support foot for a modular safety rail system comprises a base plate having upper and lower surfaces and an outer periphery, a plurality of sockets positioned inwards of the periphery and extending from the upper surface for location of a vertical post, a plurality of webs provided at the upper surface and each extending from a socket towards the periphery, each web extending from the base plate to an upper edge surface of the web, the lower surface of the base plate having at least one recess whereby when one support foot is stacked on top of another at least one of a distal end of a socket and an upper edge of a web engages the recess to prevent lateral movement of the feet, and the upper edge surface of each web being able to support the lower surface of a superimposed support foot to resist toppling.

This application is a continuation in part of our U.S. patent application. No. 10/611,982 filed on Jul. 3, 2003.

### BACKGROUND OF THE INVENTION

This invention relates to a support foot for a modular type safety rail system and in particular, though not exclusively, to a support foot for a modular safety rail system suitable for use in providing free-standing roof edge protection.

Modular type safety rail systems are well known and typically comprise straight lengths of metal tubing inter-connected by connectors of different types such that, for example, two, three or four way inter-connections of horizontally and vertically extending tubes may be achieved.

Tubes serving as vertical posts of a safety rail, and relative to which horizontally extending tubes are connected, are supported conventionally by metal base plates. These generally need to be of a robust, heavy construction thereby to provide firm support for the vertical posts. Many different designs of base plates have been proposed, but different designs suffer different disadvantages. Thus some are relatively expensive to manufacture whilst others do not lend themselves to ease of use, for example ease of securing the vertical posts to the base plates and/or ease of securing toe boards of different sizes or in different orientations. Other designs do not lend themselves readily to being stacked safely in a manner which is inherently adapted to resist toppling of the stacked assembly.

### SUMMARY OF THE INVENTION

The present invention seeks to provide an improved support foot for a modular safety rail system in which at least some of the aforedescribed disadvantages of known base plates are mitigated or overcome. The invention seeks also to provide also a safety rail assembly comprising a plurality of said support feet.

In accordance with one aspect of the present invention there is provided a support foot for a modular safety rail system, said support foot being adapted to provide location for a vertical member of the safety rail system and to provide location for a toe board which may be arranged, in use, to extend between two successive, spaced apart support feet, each said support foot comprising:—
a base plate having upper and lower surface regions and an outer periphery;
a plurality of location formations positioned inwards of said outer periphery and each extending from said upper surface for location of a vertical member;
a plurality of web formations provided at said upper surface and each extending from a respective location formation in a direction towards said outer periphery, each web formation extending from the upper surface of the base plate to an upper edge of the web formation, and
the lower surface of the base plate having at least one recess region shaped and positioned such that when one said support foot is stacked on top of a second said support foot at least one of a distal end of a location formation and an upper edge of a web formation of said second said support foot engages with said recess region of said one said support foot to prevent lateral movement of said one said support foot relative to said second said support foot.

Preferably the support foot comprises at least three location formations. Said location formations may be arranged in a non-linear configuration such that when one support foot is stacked superimposed on another support foot, the location formations are able to provide a substantially stable support and resistance to toppling of the uppermost of the two support feet. The location formations more preferably are substantially uniformly spaced from one another.

The upper edge of each said web formation of said second said support foot may to be contactable by the lower surface of said one said support foot thereby to resist toppling of the superimposed support foot, especially, for example, in an arrangement in which it is a location formation which engages with said recess region. In addition to being able to resist toppling of superimposed support feet, the upper edge of each of at least some of the web formations may be employed to support the weight of superimposed support feet. Alternatively, or additionally, the distal end of a, more preferably each, location formation may be employed to support the weight of superimposed support feet.

The invention envisages that preferably the support foot comprises at least three support webs, each of the support webs preferably being uniformly spaced apart. In a preferred embodiment of the invention the support foot comprises four support webs each extending in a direction substantially perpendicular relative to the two support webs between which it is positioned. In the case of a support plate having four webs, two successive webs preferably have the support surfaces thereof facing in an anti-clockwise direction whilst the other two webs have the support surfaces thereof facing in a clockwise direction. As an alternative to, for example, three or four spaced support webs, the support foot may comprise three or four pairs of webs, the two webs of each pair being spaced apart sufficiently to allow a toe board to be positioned therebetween.

The invention further teaches that preferably each location formation will have a web formation or pair of web formations associated therewith, but it does not exclude the possibility of one or more additional location formations devoid of an associated web formation. Preferably each web formation is arranged to provide structural support for, and be supported by, a location formation. One or more of the web formations may be supported relative to said upper surface of the base plate by means of a reinforcing rib. If web formations are provided in pairs, each web formation of the pair may be supported by a respective reinforcing rib.

Each location formation typically may be in the form of a barrel which defines a socket having a central, typically cylindrical, bore which in use receives an end of a vertical post comprised by for example a rigid rod or tube. A location formation may be provided with retention means, such as a screw threaded aperture for receiving a grub screw which may be tightened to engage with the outer surface of a rod or tube inserted into the socket formation thereby to enable the vertical member to be positively located axially, in a vertical direction, relative to the support foot. A location formation may comprise two retention means, e.g. two grub screw apertures, arranged axially spaced as considered in the length direction of the major axis of the location formation. Additionally or alternatively it may comprise a pair of substantially diametrically opposed retention formations.

Another suitable type of retention means comprises a hole, preferably a pair of diametrically opposite holes, in the wall of a location formation such that a retention pin may be inserted through the location formation and through one or a pair of aligned holes of an inserted vertical member. The pin may comprise a toggle device to inhibit inadvertent removal.

It is further preferred that the distal ends of the location formations extend further from the base plate than the web formations, and that the lower surface of the base plate is provided with one or a plurality of individual recesses to accommodate the distal ends of the location formations in a manner in which, when one support foot is stacked on top of another, relative lateral movement of the two support feet is restrained by the presence of the distal ends of the location formations in said recess or recesses. Alternatively or additionally the base plate may have at least one recess for engagement by the upper edge surface region of a web formation to restrain said relative lateral movement.

The weight of the upper of a pair of vertically aligned support feet may be supported by upper surfaces of the web formations of the lower of the two support feet. Alternatively, said weight may be supported normally by the distal end of the or each location formation of the lower of the two support feet, in which case, optionally, the upper surfaces of the web formations may lie slightly spaced from the lower surface of the superimposed foot such that they may be contacted by that surface to resist toppling if the stack departs from a truly vertically aligned condition. Said spacing may be sufficiently small to ensure that there is resistance to toppling of a stack of at least five said support feet.

If an upper edge of a web formation is available to provide support for a superimposed second support foot, preferably it is able to provide that support at a position of that upper edge which lies furthest from the associated location formation, preferably at a position substantially aligned with the outer periphery of the base plate thereby to assist in providing good resistance to relative toppling movements.

A web formation may be provided with retention means for enabling a toe board to be secured relative thereto. A web formation may be provided with an aperture to enable a toe board to be secured to the web formation by a screw or nut and bolt assembly. The aperture may be of elongate form, for example, it may be in the form of a slot, to aid alignment with pre-existing opening in a toe board. Additionally or alternatively a toe board may be located relative to the support foot by engaging in a slot provided in the base plate of the support foot, with a face of the web formation lying adjacent an edge of the slot thereby to provide a support function for the toe board.

A slot in the base plate may extend for only part of the distance from the outer periphery of the base plate towards a location formation such that, if desired, instead of the toe board being located in the slot and thus resting directly on the same roof or ground surface as that on which the support rests, the toe board may be supported elevated above the roof or ground surface by a distance corresponding to the thickness of the base plate. To enable greater than average thickness toe boards to be secured to a web formation in a slightly elevated position, with the base of the toe board resting on the upper surface of the base plate, a web formation may be provided at only one side of the slot. If web formations are provided in pairs, the two formations of a pair may be spaced apart by a distance equal at least to the maximum expected thickness of a toe board.

The upper surface of the base plate may be provided with one or more handle formations to enable the support foot readily to be lifted for transportation.

The base plate may be provided with a pair of handle formations each disposed substantially adjacent said outer periphery of the base plate. Preferably they are symmetrically positioned such that when the support foot is lifted by said handles, it remains balanced, for example with the base plate tending to remain horizontal. Each handle may be of elongate form, for example of arcuate form, and in that case preferably each handle is disposed to extend generally lengthwise in a direction which is substantially perpendicular to the direction in which the two handles lie spaced apart. The base plate may comprise one or more additional handles, for example a handle provided substantially centrally of the base plate.

A handle formation may extend upwards from the base plate by a distance substantially equal to, in some cases preferably less than, the distance by which web formations extend from the base plate.

The base plate, location formations, web formations and any handle formations preferably may be formed integrally with one another, for example in the form of a casting of iron or other metal. However, for example, a part of the support foot, such as a handle, may be pre-forged and then integrated with the remainder of the foot during a casting operation.

Each web formation preferably is formed integral with a location formation over a substantial part of the distance for which the location formation extends from the upper surface of the base plate thereby to provide a stiffening or other strengthening of the location formation. In turn, each web formation may be provided with a reinforcing formation, which may be in form of a rib, at a side opposite that face of the web formation which in use may be contacted by a toe board thereby to enhance the resistance of the web formation to sideways, bending movement under action of the toe board.

The base plate typically is of substantially uniform thickness, and also typically has upper and lower surfaces which are substantially planar. The outer periphery may be circular, but other peripheral shapes such as square or polygonal are not excluded from the scope of the invention.

The support foot of the present invention exhibits a high degree of strength and rigidity in a construction which avoids excessive use of materials and is relatively well adapted to manufacture by, for example, a casting technique. Importantly, the construction also facilitates a plurality of the support feet to be stacked one on top of another in a substantially stable configuration in which relative lateral movement is resisted by location of the distal ends of the location formations in the recesses of the lower surface of an adjacent support foot. Furthermore, the lower surface of a superimposed support foot may be well supported, or supportable, close to the outer periphery thereof by the outer regions of the upper edges of the web formations of the underlying support foot.

### BRIEF DESCRIPTION OF THE DRAWINGS

Embodiments of the present invention will now be described, by way of example only, with reference to the accompanying diagrammatic drawings in which:—

FIG. 1 is a perspective view of the upper part of a support foot in accordance with a first embodiment of the present invention;

FIG. 2 is a perspective view of the underneath of the support foot of FIG. 1;

FIG. 3 is a perspective view of a modular safety rail installation comprising a plurality of support feet each in accordance with the present invention;

FIG. 4 is a perspective view of the upper part of a support foot in accordance with a second embodiment of the present invention;

FIG. 5 is a plan view of the upper surface of the support foot of FIG. 4;

FIG. 6 is a plan view of the underneath of the support foot of FIG. 4;

FIG. 7 is a section on the line Y-Y of FIG. 5;

FIG. 8 is a section on the line X-X of FIG. 5, and

FIG. 9 is a side view in the direction of Z of FIG. 5.

### DETAILED DESCRIPTION OF THE PREFERRED EMBODIMENTS

A cast iron support foot 10 for a modular safety rail system comprises a base plate portion 11 which is generally of a disc type shape comprising an upper surface 12, a lower surface 13 and an outer periphery defined by a substantially cylindrical edge 14.

The base plate 11 is of a substantially planar form having a uniform thickness except that, as described in more detail below, the lower surface 13 is provided with recesses and the upper surface 12 has a plurality of portions which are integral with the base plate and extend therefrom.

The upper surface 12 is provided, near to but spaced from the centre thereof, with four location formations each adapted for location of a vertical post. Each location formation is in the form of a socket 15 having a through-bore 16. The four sockets 15 are uniformly circumferentially spaced about the major axis of said cylindrical edge surface 14. Each socket is provided with a screw threaded aperture 17 for a grub screw (not shown) which can be tightened to bear against the outer surface of a vertical post inserted in the bore 16 thereby to secure that post against rotation or longitudinal movement relative to the socket. (In an alternative embodiment, not illustrated, the socket may be provided with a pair of diametrically opposite holes and a pin with a toggle end retainer is inserted through those holes and a pair of pre-formed holes in the end of a post to provide said location).

Each socket 16 provides support for and is in part supported by a web 18 that extends radially outwards from the socket to the outer cylindrical edge surface 14. The web is a very substantially planar form and lies in a plane perpendicular to the upper surface 12 of the base plate 11.

Each web 18 has an upper edge surface 19 which extends parallel with the base plate surface 12 and lies spaced from said surface 12 by a distance slightly less than the spacing from said surface 12 of the distal end 20 of the socket 15. The upper edges 19 of the four webs all lie at the same height from the base plate surface 12. Similarly, the distal ends 20 of the sockets all lie at the same spacing from the surface 12.

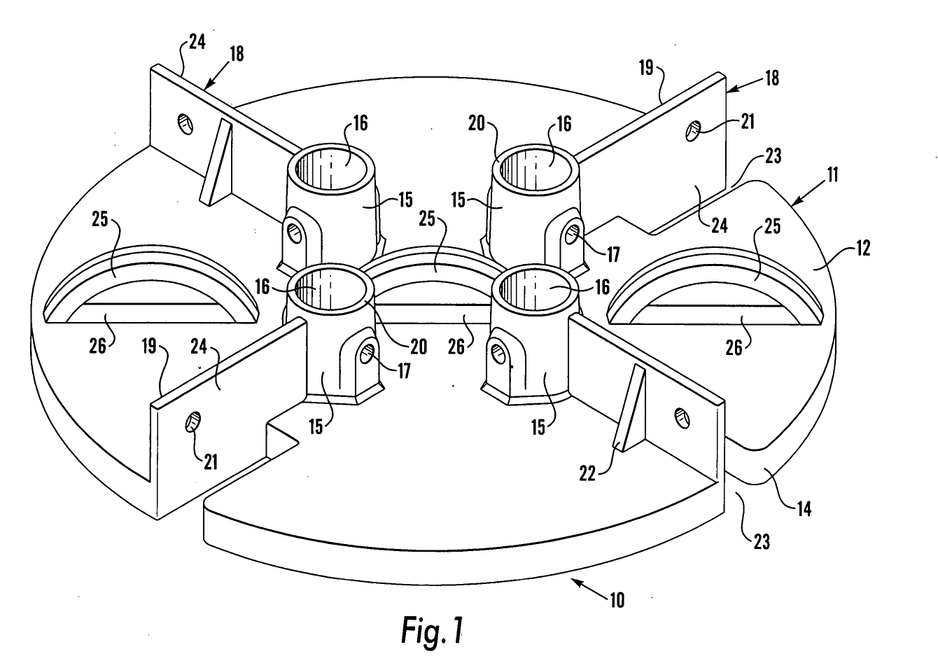

The web formations 18 are provided in an asymmetric configuration in which as viewed in FIG. 1, two successive webs 18 have the support surfaces 24 thereof facing in an anti-clockwise direction whilst the other two webs have the support surfaces 24 thereof facing in a clockwise direction. In consequence, when two of the support feet are arranged spaced apart with two web formations of one support foot aligned substantially with two webs of the other support foot, the web support surface of one support foot at one end of the toe board faces in the same direction as the web support surface of the support foot at the other end of the toe board.

Each web is provided with an aperture 21 to allow a toe board of a safety rail installation to be bolted to that web.

In addition to the support which each socket 15 provides for an associated web 18, each web is supported by a reinforcing rib 22 at that surface of the web opposite that to which it is intended that, in use, a toe board is to be secured and supported.

The base plate comprises four uniformly circumferentially spaced slots 23 each lying adjacent a respective web support surface 24. Each slot 23 extends radially inwards towards a socket 15 for a distance substantially equal to two thirds of the radial length of the web 18.

In addition to the sockets and webs the upper surface 12 has three handle formations 25 extending therefrom. The central handle typically is for use by a crane hook, and the end handles enable two persons to move the foot manually. Each handle 25 extends to a maximum distance from the upper surface 12 of the base plate which is less than the spacing of the web upper edge surface 19 from the base plate surface 12. The base plate additionally comprises three slots 26 each aligned with and positioned underneath a respective one of the handles 25. (In an alternative embodiment, the end handles are each disposed generally perpendicular to the illustrated position and close to the edge 14; to increase their robustness when in that orientation where they are potentially more exposed to damage they may be of a pre-forged type).

The lower surface 13 of the base plate comprises four recess regions 27 each aligned with a respective one of the socket through-bores 16. Each recess 27 has a depth slightly less than the distance by which the distal end 20 of each socket extends beyond the upper edge surface 19 of an associated web. When a plurality of the support feet are stacked one on top of another, the distal ends 20 of the sockets can be orientated to lie in the recesses thereby to restrain relative lateral movement of two successive support feet. In addition, in that stacked configuration, each superimposed support foot has the lower surface thereof supported by the distal ends 20 of the sockets 15. The upper edges 19 of the webs then lie close to but slightly spaced from the superimposed foot so that they can be contacted by that foot to provide a resistance to toppling if the superimposed foot is caused to depart from a truly vertically aligned position. The webs are able to provide that support at radially outer positions substantially aligned with the outer cylindrical edge 14 of the base plate 11 and thereby are particularly effective to offer stable support and resistance to toppling of a stacked plurality of the support feet.

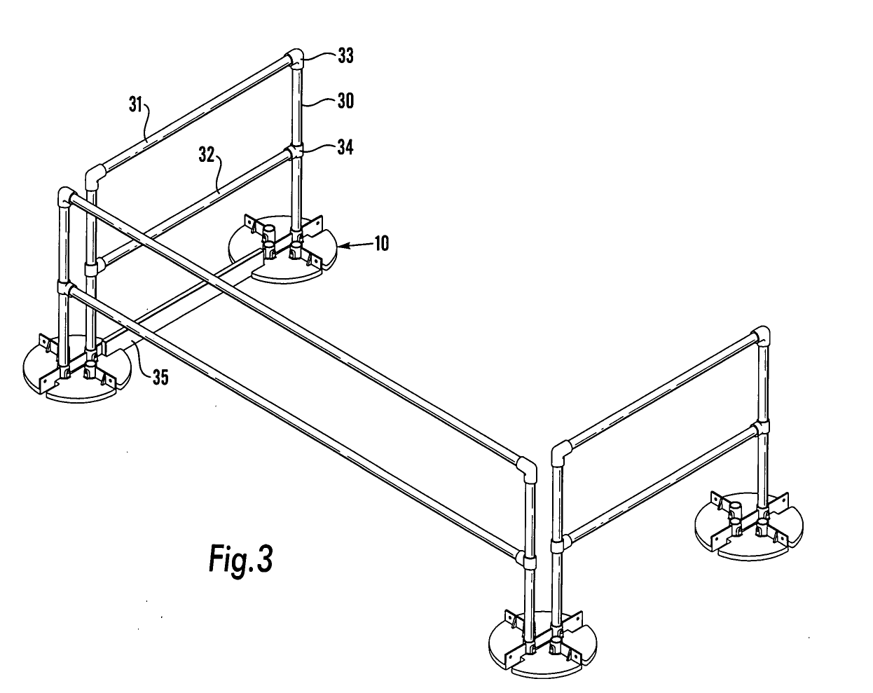

In the safety rail assembly shown in FIG. 3 four of the aforedescribed support feet 10 are employed to support six vertical posts 30. Upper horizontal rails 31 and mid-height horizontal rails 32 extend between the posts of each successive pairs of posts and are connected to the vertical posts in known manner by 90° connectors 33 and T connectors 34. The support feet are orientated such that two of the web formations of each support foot lie parallel with two web formations of a successive support foot. In consequence a toe board 35 (one only illustrated for clarity) can be secured to the co-planar faces of web formations of two successive support feet arranged at the respective ends of the board 35.

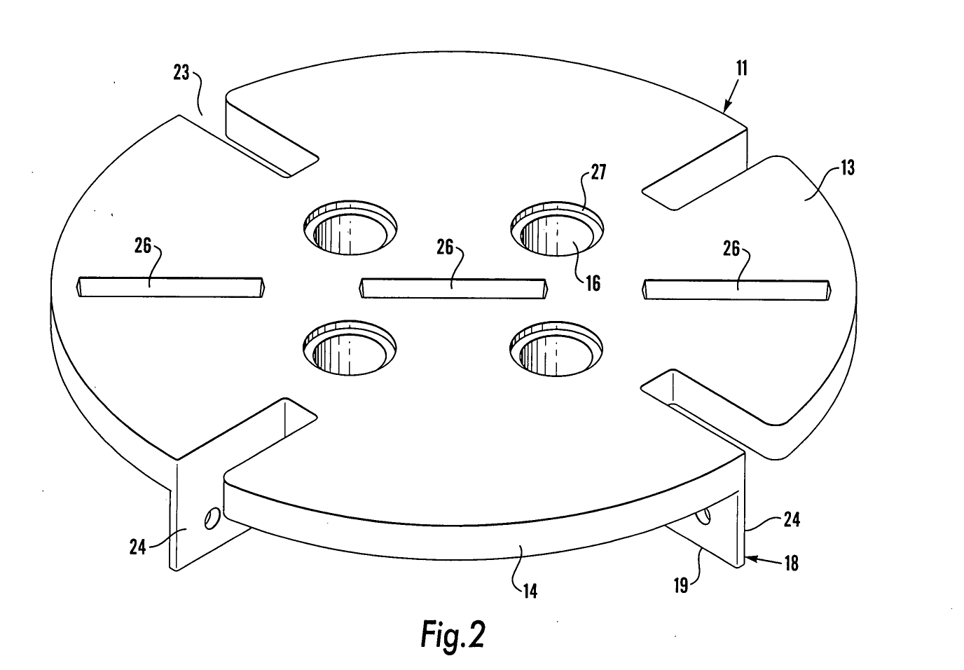

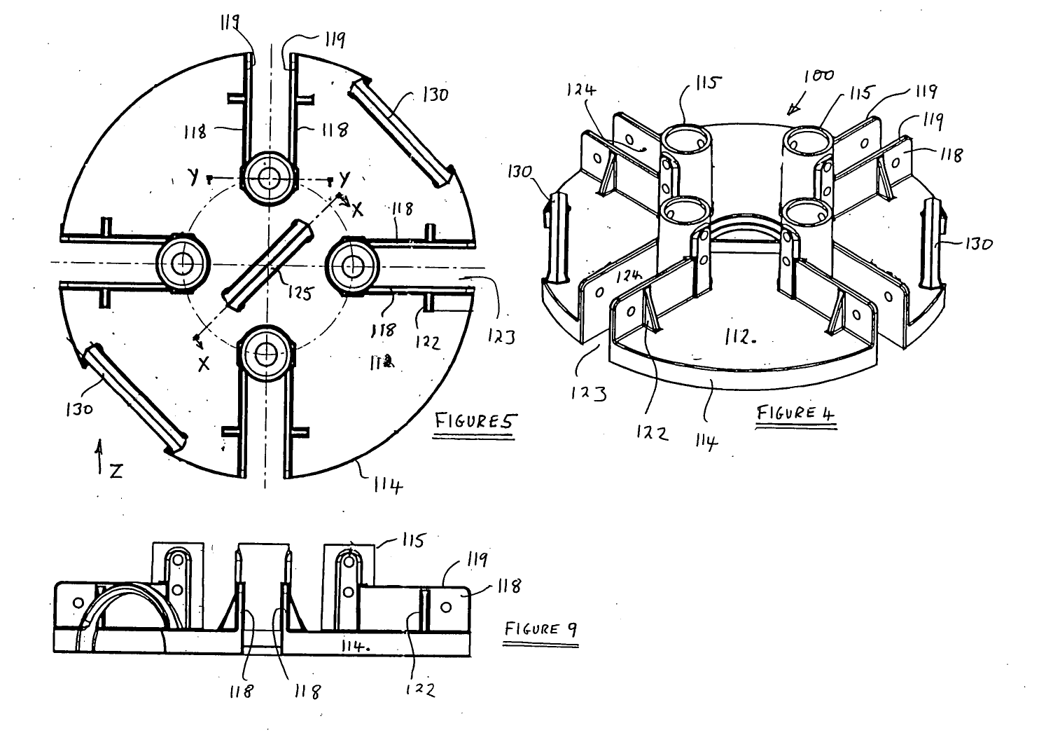

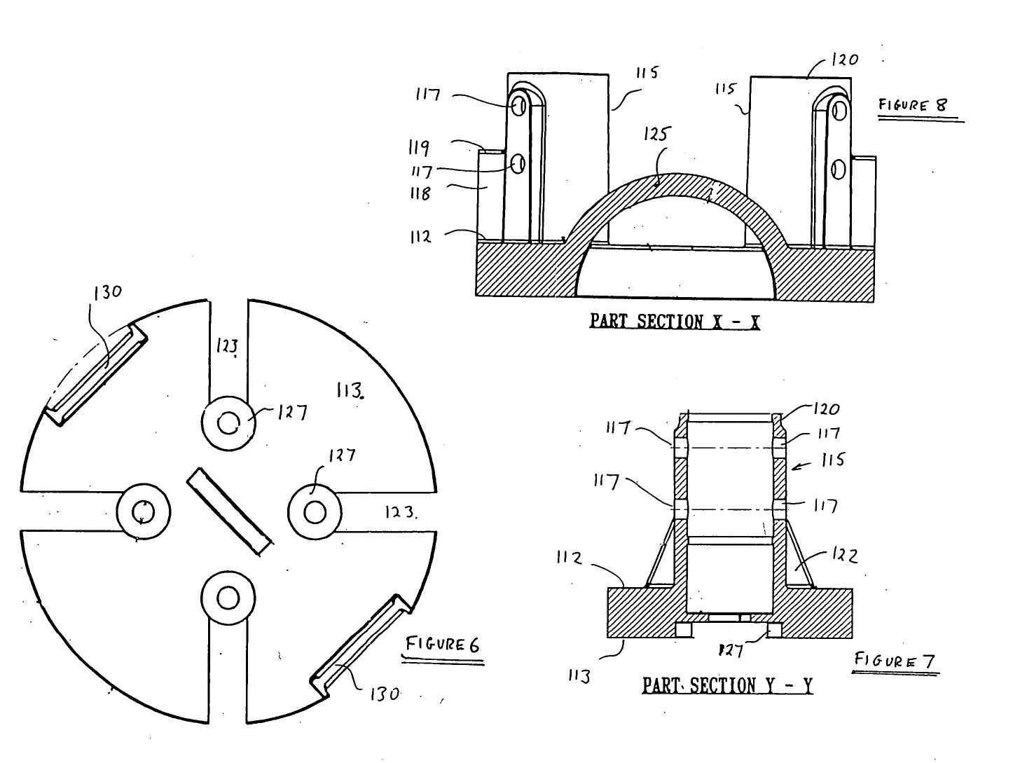

FIGS. 4 to 9 show a support foot 100 in accordance with a second embodiment of the invention. The support foot 100 is of a construction substantially similar to that of FIGS. 1 and 2, but differs in the following respects.

The support foot 100 has four location formation sockets 115 which each extend from the base plate surface 112 by a distance significantly greater, in this case 90% greater, than the distance by which the upper edges 119 of the webs 118 lie above that surface 112. The upper edge 120 of each socket 115 has an outer diameter which is slightly less than that of the remainder of the length of the socket so as to assist initial location of the sockets into the recess regions 127 in the lower surface 113 of the base plate.

Each socket 115 is provided with two pairs of diametrically opposed grub screw apertures 117 which are spaced apart relative to the length of the socket.

The toe board slots 123 in this embodiment do not terminate at a position spaced from a respective socket. Instead, each slot 123 extends radially inwards to a respective socket 115. Each slot 123 has associated therewith a pair of web formations 118, each formation 118 having a planar support surface 124 which is parallel with the confronting support surface of the other formation of the pair. The two surfaces 124 are spaced by a distance equal to the width of the slot 123. Each web formation of a pair is supported by a reinforcing rib 122, and each web formation of a pair is integral with a common socket formation such that each web formation and the socket provide mutual support.

The support foot 100 of this embodiment differs also in respect of the two handle formations, though the centre handle 125, typically for use when the foot is to be lifted by a crane, is of the same general construction. In this embodiment the two outer handles 130, of elongate curved shape, do not lie aligned in their lengthwise directions. Instead they are orientated substantially perpendicular to the direction in which they are spaced apart. That is, they each lie substantially tangentially relative to the cylindrical outer edge surface 114.

The support foot of FIGS. 4 to 9 may be used in the same manner as the support foot of FIGS. 1 and 2 to form a safety rail installation such as that shown by way of example in FIG. 3.

1. A support foot for a modular safety rail system, said support foot being adapted to provide location for a vertical member of the safety rail system and to provide location for a toe board which may be arranged, in use, to extend between two successive, spaced apart support feet, each said support foot comprising:—
a base plate having upper and lower surface regions and an outer periphery;
at least three location formations positioned inwards of said outer periphery and each extending from said upper surface for location of a vertical member;
a plurality of web formations provided at said upper surface and each extending from a respective location formation in a direction towards said outer periphery, each web formation having an upper edge and the web formation extending upwards from the upper surface of the base plate to said upper edge, and
the lower surface of the base plate having at least one recess region shaped and positioned such that when one said support foot is stacked on top of a second said support foot at least one of a distal end of a location formation and an upper edge of a web formation of said second said support foot engages with said recess region of said one said support foot to prevent lateral movement of said one said support foot relative to said second said support foot.

2. A support foot according to claim 1, wherein the distal ends of the location formations extend further from the base plate than the web formations.

3. A support foot according to claim 2, wherein the lower surface of the base plate is provided with one or a plurality of individual recesses to accommodate the distal ends of the location formations in a manner in which, when one support foot is stacked on top of another, the weight of the upper of a pair of support feet is supported by the distal end of at least one of said location formations of the lower of the two support feet, with relative lateral movement of the two support feet being restrained by the presence of the distal ends of the location formations in said recess or recesses.

4. A support foot according to claim 3, wherein when one support foot is stacked on top of another a spacing exists between the upper edge surfaces of the web formations of the lower support foot and the lower surface of the upper of the two support feet.

5. A support foot according to claim 2, wherein the lower surface of the base plate is provided with one or a plurality of individual recesses to accommodate the distal ends of the location formations in a manner in which, when one support foot is stacked on top of another, the weight of the upper of a pair of support feet is supported by upper edge surfaces of the web formations of the lower of the two support feet, with relative lateral movement of the two support feet being restrained by the presence of the distal ends of the location formations in said recess or recesses.

6. A support foot according to claim 1, wherein upper edge surfaces of the web formations are each able to provide support for a superimposed second support foot at a position of that upper edge which lies furthest from the associated location formation.

7. A support foot according to claim 6, wherein said upper edge surfaces are each able to provide support for a superimposed second support foot at a position substantially aligned with the outer periphery of the base plate.

8. A support foot according to claim 1, wherein the support foot comprises at least three support webs.

9. A support foot according to claim 1, wherein the support foot comprises four support webs each extending in a direction substantially perpendicular relative to the two support webs between which it is positioned.

10. A support foot according to claim 9, wherein two successive webs have the support surfaces thereof facing in an anti-clockwise direction and the other two webs have the support surfaces thereof facing in a clockwise direction.

11. A support foot according to claim 1, wherein each web formation provides structural support for, and is supported by, a location formation.

12. A support foot according to claim 1, wherein each location formation comprises a socket having a central cylindrical bore which in use receives an end of a vertical member, and retention means to enable the vertical member to be positively located axially, in a vertical direction, relative to the support foot.

13. A support foot according to claim 1, wherein the base plate comprises a slot adapted to receive a part of a toe board and a web formation has a face which lies adjacent an edge of the slot thereby, in use, to provide a support function for a toe board positioned in said slot.

14. A support foot according to claim 13, wherein the slot extends for only part of the distance from the outer periphery of the base plate towards a location formation.

15. A support foot according to claim 1, wherein the base plate, location formations, and web formations are formed integrally with one another in the form of a casting.

16. A support foot according to claim 1, wherein each web formation is formed integral with a location formation over a substantial part of the distance for which the location formation extends from the upper surface of the base plate.

17. A support foot according to claim 1, wherein each web formation is provided with a reinforcing formation, at a side opposite that face of the web formation which in use is contacted by a toe.

18. A support foot according to claim 1, wherein the outer periphery of the base plate is circular.

19. A support foot for a modular safety rail system, said support foot being adapted to provide location for a vertical member of the safety rail system and to provide location for a toe board which may be arranged, in use, to extend between two successive, spaced apart support feet, each said support foot comprising:—
a base plate having upper and lower surface regions and an outer periphery;
four location formations positioned inwards of said outer periphery and each extending from said upper surface for location of a vertical member;
four web formations provided at said upper surface and each extending from a respective location formation in a direction towards said outer periphery, each web formation having an upper edge and the web formation extending upwards from the upper surface of the base plate to said upper edge;
each web formation extending in a direction substantially perpendicular to the two support webs between which it extends, and two successive webs having the support surfaces thereof facing in an anti-clockwise direction and the other two webs facing in a clockwise direction, and
the lower surface of the base plate having at least one recess region shaped and positioned such that when one said support foot is stacked on top of a second said support foot at least one of a distal end of a location formation and an upper edge of a web formation of said second said support foot engages with said recess region of said one said support foot to prevent lateral movement of said one said support foot relative to said second said support foot.

20. A support foot for a modular safety rail system, said support foot being adapted to provide location for a vertical member of the safety rail system and to provide location for a toe board which may be arranged, in use, to extend between two successive, spaced apart support feet, each said support foot comprising:—
a base plate having upper and lower surface regions and an outer periphery;
a plurality of location formations positioned inwards of said outer periphery and each extending from said upper surface for location of a vertical member;
a plurality of web formations provided at said upper surface and each extending from a respective location formation in a direction towards said outer periphery, each web formation having an upper edge and the web formation extending upwards from the upper surface of the base plate to said upper edge;
the base plate comprising a slot adapted to receive a part of a toe board and the face of a web formation lying adjacent an edge of the slot thereby, in use, to provide a support function for a toe board positioned in said slot, said slot extending for only part of the distance from the outer periphery of the base plate towards a location formation, and
the lower surface of the base plate having at least one recess region shaped and positioned such that when one said support foot is stacked on top of a second said support foot at least one of a distal end of a location formation and an upper edge of a web formation of said second said support foot engages with said recess region of said one said support foot to prevent lateral movement of said one said support foot relative to said second said support foot.

21. A support foot according to claim 1, wherein a pair of web formations extend from at least one location formation.

22. A support foot according to claim 21, wherein the support foot comprises four location formations and a pair of mutually parallel and spaced apart web formations extend from each location formation.

23. A support foot according to claim 1, wherein a pair of handles extend upwards from the upper surface region of the base plate, each handle being of elongate form, the two handles of the pair being provided substantially adjacent substantially opposite edge regions of the base plate and said elongate handles each extending in a lengthwise direction which is substantially perpendicular to the direction in which the two handles of the pair are spaced apart.
